(19) United States
(12) Patent Application Publication
(10) Pub. No.: US 2007/0146821 A1
(43) Pub. Date: Jun. 28, 2007

(54) Image reading apparatus and method thereof

(75) Inventor: Seung-je Joh, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/604,802

(22) Filed: Nov. 28, 2006

(30) Foreign Application Priority Data
Dec. 22, 2005 (KR) 2005-128152

(51) Int. Cl. H04N 1/04

(52) U.S. Cl. 358/482

(57) ABSTRACT

An image reading apparatus, comprising an image reading module having an image sensor to read an image from a document and a timing generator to generate a driving clock to control the image sensor, a main controller to output an enabling clock to the timing generator, and an analog-to-digital (A/D) converter to convert an analog signal output from the image sensor into a digital signal.

### CROSS-REFERENCE TO RELATED APPLICATION

This application claims the benefit of Korean Application No. 2005-128153, filed Dec. 22, 2005 in the Korean Intellectual Property Office, the disclosure of which is incorporated herein by reference.

### BACKGROUND OF THE INVENTION

1. Field of the Invention

Aspects of the present invention relate to an image reading apparatus and a method thereof. More particularly, aspects of the present invention relate to an image reading apparatus and a method thereof by improving a location of a timing generator to generate a driving signal for an image sensor of the image reading apparatus.

2. Description of the Related Art

In general, an image forming apparatus with a scanning function, such as a scanner, facsimile and digital copier, has an image reading sensor unit to read an image from a document. The image reading sensor unit projects light onto a document and converts light reflected from the document into an electric output value, such as charged couple device (CCD) or complementary metal oxide semiconductor (CMOS).

FIG. 1 schematically shows a conventional scanning device. As shown in FIG. 1, a transparent platen glass 20 is formed on the upper side of a main body 10 of the image reading apparatus and an image reading module 30 is movably formed under the platen glass 20. The main body 10 has a motor 40. A driving force of the motor 40 is transmitted to the image reading module 30 by a pair of driving pulley 51, 52 and a timing belt 60.

FIG. 2 is a block diagram to describe a driving of an image sensor in the conventional image reading apparatus. As shown in FIG. 2, the main body 10 of the image reading apparatus includes a main controller 70 to supply power, drive the motor 40 and control the entire operation of the image reading apparatus. The image reading module 30 includes an image sensor 31 to receive a driving signal from the main controller 70 and scan an image.

The main controller 70 includes a clock generator 71, a timing generator 73 and an analog-to-digital (A/D) converter 75. The clock generator 71 outputs an enabling clock 76 to operate the timing generator 73. Then, the timing generator 73 outputs a driving clock 77 to the image sensor 31. Subsequently, the image sensor 31 operates according to the driving clock 77 to read the image from the document.

Next, an analog signal 78 output through the image sensor 31 is converted into a digital signal through the A/D converter 75. The driving clock 77 and the analog signal 78 move through a flexible flat cable 80. Here, it is essential to control the driving clock 77 for high-speed operation of such image reading module 30. However, the timing generator 73 is conventionally formed in the main controller 70 and the driving clock 77 is sent through the flexible flat cable 80. Thus, electro magnetic interference (EMI) is a problem and there occurs difficulty with signal matching.

### SUMMARY OF THE INVENTION

An aspect of the present invention is to solve at least the above problems and/or disadvantages and to provide at least the advantages described below. Accordingly, an aspect of the present invention is to provide an image reading apparatus to solve problems related to the signal to noise ratio (SNR) such as EMI by improving a location of a timing generator.

Another aspect of the present invention is to provide an image reading method using the above image reading apparatus.

According to an aspect of the present invention, there is provided an image reading module having an image sensor to read an image from a document and a timing generator to generate a driving clock to control the image sensor; a main controller to output an enabling clock to the timing generator; and an analog-to-digital (A/D) converter to convert an analog signal output from the image sensor into a digital signal.

According to an aspect of the invention, the signal output from the image sensor may be transmitted to the main controller in the complementary metal oxide semiconductor (CMOS) form.

According to an aspect of the invention, the signal output from the image sensor may be transmitted to the main controller in the low voltage differential signaling (LVDS) form.

According to an aspect of the invention, the image reading apparatus may further comprise an LVDS transmitter to convert the signal output from the image sensor into a signal of the LVDS signal level and transmitting the signal, and an LVDS receiver to convert the signal received from the LVDS transmitter into a signal of the original level.

According to an aspect of the invention, the LVDS transmitter may be formed in the image reading module and the LVDS receiver may be formed in the main controller. The image sensor may be a charged couple device (CCD) sensor. The image reading module may be formed to linearly reciprocate.

According to an aspect of the invention, the A/D converter may be formed in the image reading module.

According to an aspect of the invention, the timing generator and the A/D converter may be formed in one package. The driving clock of the A/D converter may be transmitted by the timing generator. The A/D converter may be formed in the main controller.

There is provided an image reading method according to another embodiment of the present invention, comprising outputting an enabling clock from a main controller to a timing generator in an image reading module, generating a driving clock from the timing generator to drive an image sensor in the image reading module, operating the image sensor by the driving clock, and converting an analog signal output from the image sensor into a digital signal through an A/D converter.

According to an aspect of the invention, the conversion of the analog signal into the digital signal through the A/D converter may be performed in the image reading module.

According to an aspect of the invention, the image reading method may further comprise outputting the enabling clock from the timing generator to the A/D converter. The image reading method may further comprise transmitting the converted digital signal to the main controller in the COMS form.

According to an aspect of the invention, the image reading method may further comprise transmitting the converted digital signal to the main controller in the LVDS form. The image reading method may further comprise converting the converted digital signal into a signal of the LVDS signal level and transmitting the signal, and converting the transmitted signal into a signal of the original signal level.

According to an aspect of the invention, conversion of the converted digital signal into the signal of the LVDS signal level and transmitting the signal may be performed in the image reading module, and converting the transmitted signal into the signal of the original signal level may be performed in the main controller.

According to an aspect of the invention, conversion of the analog signal into the digital signal through the A/D converter may be performed in the main controller.

According to an aspect of the invention, the analog signal output from the image sensor may be transmitted to the A/D converter in the CMOS form.

According to an aspect of the invention, the analog signal output from the image sensor may be transmitted to the A/D converter in the LVDS form.

According to an aspect of the invention, the image reading method may further comprise converting the analog signal output from the image sensor into a signal of the LVDS signal level and transmitting the signal, and converting the transmitted signal into a signal of the original level and transmitting the signal to the A/D converter.

According to an aspect of the invention, the conversion of the analog signal output from the image sensor into the signal of the LVDS signal level and transmitting the signal may be performed in the image reading module, and converting the transmitted signal into the signal of the original level may be performed in the main controller.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view to partially show the configuration of a conventional image-reading apparatus;

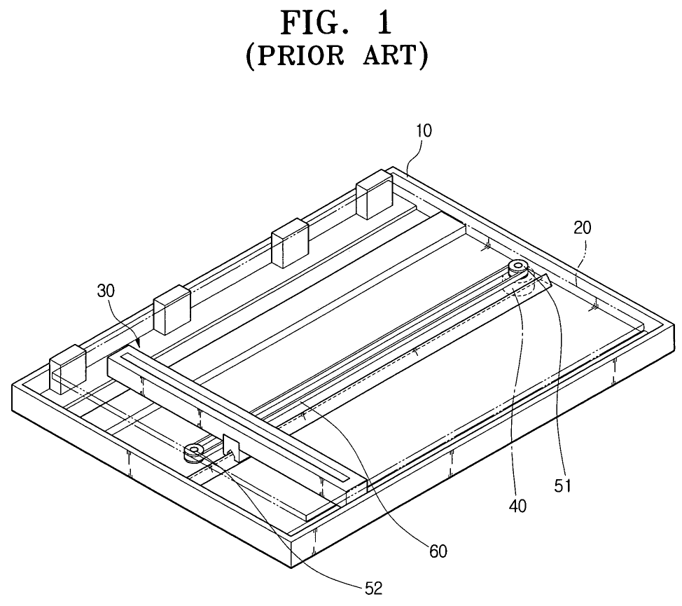

FIG. 2 is a block diagram to describe driving of an image reading module in a conventional image reading apparatus;

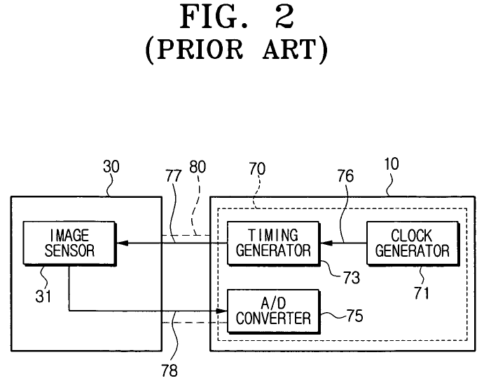

FIG. 3 is a perspective view to show the configuration of an image reading apparatus according to an embodiment of the present invention;

FIG. 4 is a block diagram to describe driving of an image reading module in an image reading apparatus according to an embodiment of the present invention;

FIG. 5 is a block diagram to describe driving of an image reading module in an image reading apparatus according to another embodiment of the present invention;

FIG. 6 is a flow chart to describe an image reading process according to the configuration of FIG. 4; and

FIG. 7 is a flow chart to describe an image reading process according to the configuration of FIG. 5.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

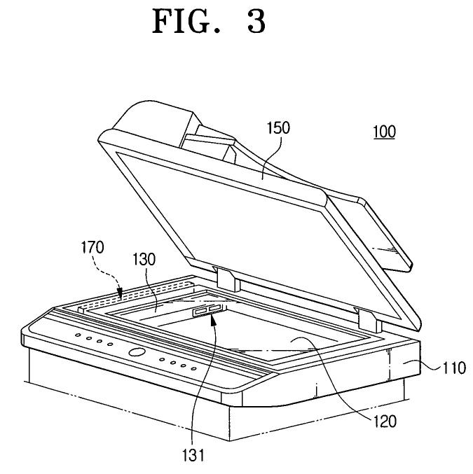

FIG. 3 is a perspective view to show the configuration of an image reading apparatus. As shown in FIG. 3, an image reading apparatus 100 includes a main body 110, a transparent platen glass 120 on which a document (not shown) may be placed, an image reading module 130 to read an image from the document, and a cover 150 to open and close the platen glass 120. The image reading module 130 linearly reciprocates under the platen glass 120. The main controller 170 is formed at one side of the main body 110 to control the entire operation of the image reading apparatus (i.e., the main controller 170 controls the supply of power and the movement of the image reading module 130). According to embodiments of the invention, the main controller 170 may be formed at other locations as needed.

The image reading module 130 includes a module controller 131 coupled with an enabling clock from the main controller 170 and thereby controls an image sensor 133. In such a configuration, the main controller 170 may comprise a main circuit board and the module controller 131 may comprise a module circuit board. However, it is understood that other controller and controller circuit boards may be used.

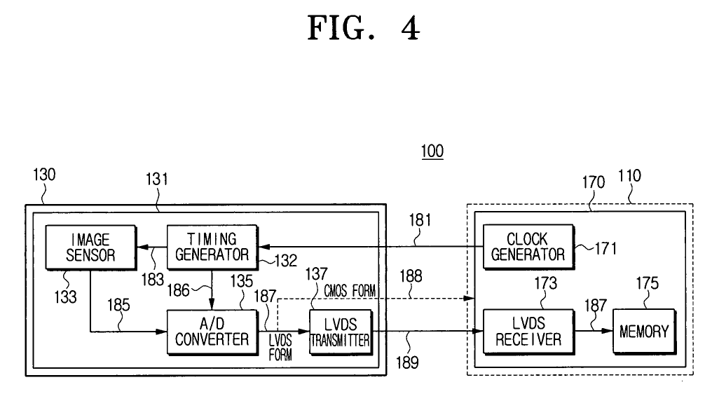

FIG. 4 is a block diagram showing an image reading module in an image reading apparatus. As shown in FIG. 4, the main controller 170 in the main body 110 includes a clock generator 171. Meanwhile, the module controller 131 in the image reading module 130 includes a timing generator 132 coupled to an enabling clock 181 from the clock generator 171, and the image sensor 133 to operate according to a driving clock 183 generated from the timing generator 132. In addition, an A/D converter 135 is also included in the module controller 131 to convert an analog signal 185 output from the image sensor 133 into a digital signal 187. The timing generator 132 also outputs an enabling clock 186 at the same time to operate the A/D converter 135. However, the timing generator 132 need not output the clock 186 in all aspects of the invention, such as where the clock 186 is received from the main body of the controller 170.

The converted digital signal 187 may be directly transmitted to the main controller 170 in the form of complementary metal oxide semiconductor (CMOS) data 188. Alternatively, as shown in FIG. 4, the converted digital signal 187 is transmitted to a memory 175 of the main controller 170 in the form of low voltage differential signaling (LVDS) data. The transmission of the LVDS signal reduces the EMI problem. In this case, an LVDS transmitter 137 to convert the converted digital signal 187 into a signal of the LVDS signal level 189 and to transmit the converted signal, and an LVDS receiver 173 to convert the signal from the LVDS transmitter 137 into a signal of the original level are needed. Here, the LVDS transmitter 137 is in the module controller 131 of the image reading module 130, and the LVDS receiver 173 is in the main controller 170. In such a configuration, the timing generator 132 and the A/D converter 135 may be implemented in one package. However, it is understood that other arrangements can be made and that other transmission techniques can be implemented to reduce EMI.

According to embodiments of the invention, the timing generator 132 may comprise a chip while the image sensor 133 may comprise a CCD sensor. However, other types of sensors can be used (such as a CMOS sensor).

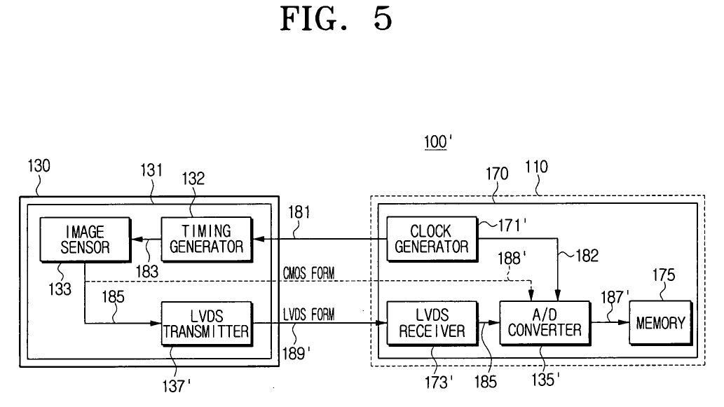

FIG. 5 is a block diagram showing an image reading module in an image reading apparatus according to another embodiment of the present invention. As shown in FIG. 5, an A/D converter 135′ is formed in the main controller 170 (in contrast to the embodiment of FIG. 4 in which the A/D converter 135 is formed in the main controller 170 of the image reading module 130). As the A/D converter 135′ is formed in the main controller 170, an LVDS transmitter 137′ converts an analog signal 185 output from the image sensor 133 into a signal of the LVDS signal level 189′ and transmits the converted signal to an LVDS receiver 173′, and the LVDS receiver 173′ converts the signal of the LVDS signal level 189′ into the original analog signal 185. While not required in all aspects, the analog signal 185 that is output from the image sensor 133 may be directly transmitted to the main controller 170 in the form of a CMOS signal 188′. Furthermore, a clock generator 171′ formed in the main controller 170 outputs enabling clocks 181, 182 for the timing generator 132 and the A/D converter 135′.

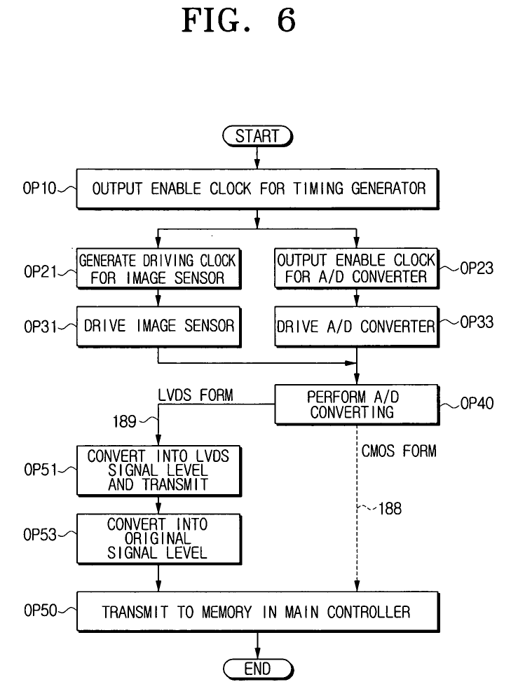

Hereinbelow, an image reading method of the image reading apparatus according to an embodiment of the present invention will be described. As shown in FIGS. 4 and 6, the clock generator 171 in the main controller 170 outputs an enabling clock 181 to operate the timing generator 132 (op₁₀). The timing generator 132 then generates a driving clock 183 to operate the image sensor 133 (op₂₁). In addition, the timing generator 132 outputs an enabling clock 186 to operate the A/D converter 135 (op₂₃). Accordingly, the image sensor 133 operates along with the A/D converter 135 according to the driving clock 183 (op₃₁ and op₃₃). An analog signal 185 that is output from the image sensor 133 is input to the A/D converter 135 and is converted into a digital signal 187 (op₄₀). The converted digital signal 187 is then transmitted to the main controller 170 (op₅₀). The transmitted signal may be in the CMOS data form 188 or LVDS data form 189 according to aspects of the invention.

If the signal is transmitted in the LVDS data form 189, the converted digital signal 187 is converted into a signal of the LVDS signal level 189 through the LVDS transmitter 137 and is then transmitted (OP₅₁). The signal of the LVDS signal level 189 is re-converted into the signal of the original level 187 through the LVDS receiver 173 and is then stored in the memory 175 (OP₅₃).

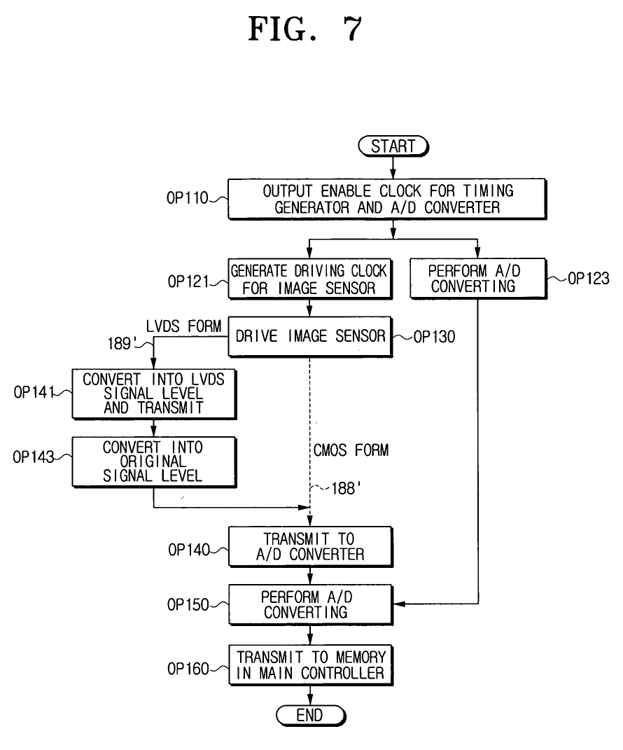

Next, an image reading method of the image reading apparatus according to another embodiment of the present invention will be described. As shown in FIGS. 5 and 7, first the clock generator 171′ in the main controller 170 outputs enabling clocks 181, 182 respectively to the timing generator 132 and the A/D converter 135′ (op₁₁₀). The timing generator 132 receives the enabling clock 181, and generates and transmits a driving clock 183 to the image sensor 133 (op₁₂₁). Meanwhile, the A/D converter 135′ receives the enabling clock 182 and operates (op₁₂₃). The image sensor 133 receives the driving clock 183 and starts to read an image (op₁₃₀), and an analog signal 185 that is output from the image sensor 133 is transmitted to the A/D converter 135′. The transmitted analog signal is then converted into a digital signal through the A/D converter 135′ (op₁₄₀). The analog signal 185 that is output from the image sensor 133 may be transmitted to the A/D converter 135′ in the CMOS form, or to the A/D converter 135′ in the LVDS form.

If the signal is transmitted in the LVDS form, the analog signal 185 that is output from the image sensor 133 is converted into a signal of the LVDS signal level 189′ through the LVDS transmitter 137′ and is then transmitted (op₁₄₁). The LVDS receiver 173′ in the main controller 170 converts the received signal into a signal of the original analog signal level 185 (op₁₄₃).

The analog signal 185 that is transmitted to the A/D converter 135′ is converted into a digital signal 187′ and transmitted to the memory 175 (op₁₆₀).

While not required in all aspects of the invention, the signals 181, 188, 189, 188′, and/or 189′ are transmitted between the modules 110, 130 using a flat cable and/or other like wired and/or wireless connections.

To describe the present invention, the image reading apparatus is exemplified in the above embodiments, but the present invention may also be applied to a multi-function apparatus combined with an image forming apparatus which forms an image based on the information acquired from the image reading apparatus.

As may be appreciated from the above description of the image reading apparatus according to the present invention, the timing generator to output a driving clock to the image sensor is formed in the image reading module so that the driving clock does not need to be transmitted through the flat cable to connect the image reading module and the main controller. Therefore, problems related to the SNR, such as EMI, and a signal matching error may be solved.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An image reading apparatus, comprising:
an image reading module having an image sensor to read an image from a document and a timing generator to generate a driving clock to control the image sensor;
a main controller in a main module other than the image reading module to output an enabling clock to the timing generator; and
an analog-to-digital (A/D) converter to convert an analog signal output from the image sensor into a digital signal.

2. The image reading apparatus of claim 1, wherein the signal output from the image sensor is transmitted to the main controller in the complementary metal oxide semiconductor (CMOS) form.

3. The image reading apparatus of claim 1, wherein the signal output from the image sensor is transmitted to the main controller in the low voltage differential signaling (LVDS) form.

4. The image reading apparatus of claim 3, further comprising an LVDS transmitter to convert the signal output from the image sensor into a signal of the LVDS signal level and to transmit the signal, and an LVDS receiver to convert the signal received from the LVDS transmitter into a signal of the original level.

5. The image reading apparatus of claim 4, wherein the LVDS transmitter is formed in the image reading module and the LVDS receiver is formed in the main controller.

6. The image reading apparatus of claim 1, wherein the image sensor is a charged couple device (CCD) sensor.

7. The image reading apparatus of claim 1, wherein the image reading module linearly reciprocates relative to the document.

8. The image reading apparatus of claim 1, wherein the A/D converter is formed in the image reading module.

9. The image reading apparatus of claim 8, wherein the timing generator and the A/D converter are formed in one package.

10. The image reading apparatus of claim 8, wherein the driving clock of the A/D converter is transmitted by the timing generator.

11. The image reading apparatus of claim 1, wherein the A/D converter is formed in the main controller.

12. An image reading method, comprising:
outputting an enabling clock from a main controller to a timing generator in an image reading module;
generating a driving clock from the timing generator to drive an image sensor in the image reading module according to the output enabling clock;
operating the image sensor according to the generated driving clock; and
converting an analog signal output from the image sensor into a digital signal through an A/D converter.

13. The image reading method of claim 12, wherein the converting of the analog signal into the digital signal through the A/D converter is performed in the image reading module.

14. The image reading method of claim 13, further comprising outputting the enabling clock from the timing generator to the A/D converter.

15. The image reading method of claim 13, further comprising transmitting the converted digital signal to the main controller in a complementary metal oxide semiconductor (CMOS) form.

16. The image reading method of claim 13, further comprising transmitting the converted digital signal to the main controller in a low voltage differential signaling (LVDS) form.

17. The image reading method of claim 16, further comprising:
converting the converted digital signal into a signal of the LVDS form and transmitting the signal; and
converting the transmitted signal into a signal of the converted digital signal.

18. The image reading method of claim 17, wherein the converting of the converted digital signal into the signal of the LVDS form and the transmitting of the signal is performed in the image reading module, and the converting of the transmitted signal into the signal of the converted digital signal is performed in the main controller.

19. The image reading method of claim 12, wherein the converting of the analog signal into the digital signal through the A/D converter is performed in the main controller.

20. The image reading method of claim 19, wherein the analog signal output from the image sensor is transmitted to the A/D converter in a complementary metal oxide semiconductor (CMOS) form.

21. The image reading method of claim 19, wherein the analog signal output from the image sensor is transmitted to the A/D converter in a low voltage differential signaling (LVDS) form.

22. The image reading method of claim 21, further comprising:
converting the analog signal output from the image sensor into a signal of the LVDS signal level and transmitting the signal from the image reading module to the main controller; and
converting the transmitted signal into the analog signal and transmitting the analog signal to the A/D converter.

23. The image reading method of claim 22, wherein the converting of the analog signal output from the image sensor into the signal of the LVDS form and the transmitting of the signal is performed in the image reading module, and the converting of the transmitted signal into the signal of the converted digital signal is performed in the main controller.

24. An image reading apparatus, comprising:
a main controller to receive a complementary metal oxide semiconductor (CMOS) data signal, the main controller including:
a selectively engageable memory,
a clock generator to generate and transmit an enabling clock, and
a receiver to receive a low voltage differential signaling (LVDS) data signal, if the memory is engaged; and
a module controller including:
a timing generator coupled to the enabling clock received from the clock generator to generate a driving clock,
an image sensor to generate an analog signal according to the driving clock,
an A/D converter to convert the analog signal into a digital signal, the digital signal being transmittable to the main controller as the CMOS data signal, and
an LVDS transmitter to convert the digital signal into the LVDS data signal and to transmit the LVDS data signal to the receiver.

25. The apparatus according to claim 24, wherein the timing generator outputs an enabling clock to operate the A/D converter.

26. An image reading apparatus, comprising:
a main controller to receive a complementary metal oxide semiconductor (CMOS) data signal, the main controller including:
a selectively engageable memory,
a clock generator to generate and transmit an enabling clock,
a receiver to receive a low voltage differential signaling (LVDS) data signal, if the memory is engaged, and
an A/D converter to transmit the CMOS data signal to the memory and/or to transmit the LVDS data signal from the receiver to the memory; and
a module controller including:
a timing generator coupled to the enabling clock received from the clock generator to generate a driving clock,
an image sensor to generate an analog signal to be transformed into the CMOS data signal according to the driving clock, and
an LVDS transmitter to convert the analog signal into the LVDS data signal and to transmit the LVDS data signal to the receiver, if the memory is engaged.

27. An image reading apparatus, comprising:
an image sensing module to move relative to a document and to read data from the document according to a received control signal, to generate an image signal from the read data, and to transmit the image signal as a complementary metal oxide semiconductor (CMOS) data signal and/or a low voltage differential signaling (LVDS) data signal; and
a main controller to send the control signal to control the image sensing module, to receive the CMOS data signal and/or LVDS data signal, and to convert the receive the CMOS data signal and/or LVDS data signal back into the image signal.
